(19) United States
(12) Patent Application Publication
(10) Pub. No.: US 2015/0149528 A1
(43) Pub. Date: May 28, 2015

(54) Methods, Systems and Apparatus to Determine a Distributed Content Share Storage Scheme

(71) Applicant: AT&T Intellectual Property I, L.P., Atlanta, GA (US)

(72) Inventors: Emiliano Miluzzo, Madison, NJ (US); Yih-Farn Chen, Bridgewater, NJ (US)

(73) Assignee: AT&T Intellectual Property I, L.P., Atlanta, GA (US)

(21) Appl. No.: 14/089,712

(22) Filed: Nov. 25, 2013

(51) Int. Cl. H04L 29/06

(52) U.S. Cl. CPC H04L 67/42
USPC 709/203

(57) ABSTRACT

Methods, apparatus, systems to determine a distributed content storage scheme are disclosed. Example methods to store a content file include generating, with a processor remote from a first client device storing content shares of the content file, a first content share storage scheme identifying a second client device to which a first subset of a first combination of the content shares is to be distributed for storage when a first client device is coupled to a first local area network. The method further includes generating, with the processor, a second content share storage scheme identifying a third client device to which a first subset of a second combination of the content shares is to be distributed for storage when the first client device is coupled to a second local area network.

### FIELD OF THE DISCLOSURE

This disclosure relates generally to electronic data storage devices and, more particularly to determining a distributed content share storage scheme for storing different shares of a content file on client devices associated with one or more networks.

### BACKGROUND

Personal mobile devices are commonly used by consumers to access media, data content, video content, audio content, etc. In some cases, the content is stored in its entirety on the mobile device at which the content is being accessed. In other cases, the content is stored on a local storage device of a local area network (“LAN”) to which the personal mobile device is communicatively coupled. In yet other cases, the content is stored on a remote storage device, such as a cloud storage device, that is accessed by the personal mobile device via, for example, wireless cellular technology, near range wireless technology (e.g., blue tooth) and/or wired communication technology (e.g., a digital subscriber line).

### BRIEF DESCRIPTION OF THE DRAWINGS

FIG. 1 is a block diagram of example distributed storage networks controlled by an example orchestrator as disclosed herein.

FIG. 2 is a block diagram of an example orchestrator to generate an example content share storage scheme for use in storing content shares of a content file among the client devices of the example distributed storage networks of FIG. 1.

FIG. 3 is a block diagram of an example content share storage scheme having an example network file list and an example network share list.

FIG. 4 is a block diagram of a first of the example client devices of the distributed storage networks of FIG. 1.

FIG. 5 is a flowchart representative of example machine readable instructions that may be executed by the example orchestrator of FIG. 1 and FIG. 2 to generate a first content share storage scheme for a first example distributed storage network.

FIG. 6 is a flowchart representative of example machine readable instructions that may be executed by the example orchestrator of FIG. 1 and FIG. 2 to enable access to a content file.

FIG. 7 is a flowchart representative of example machine readable instructions that may be executed by the example orchestrator of FIG. 1 and FIG. 2 to generate a second content share storage scheme for a second example distributed storage network.

FIG. 8 is a flowchart representative of example machine readable instructions that may be executed by the example orchestrator of FIG. 1 and FIG. 2 to detect and replace corrupt content shares stored on one of the example client devices of the distributed storage networks of FIG. 1.

FIG. 9 is a flowchart representative of example machine readable instructions that may be executed by the first example client device of FIG. 4 to obtain a content share storage scheme for a downloaded content file.

FIG. 10 is a flowchart representative of example machine readable instructions that may be executed by the first example client device of FIG. 4 to access a content file stored as content shares distributed among the client devices of the distributed storage networks of FIG. 1.

FIG. 11 is a flowchart representative of example machine readable instructions that may be executed by the first example client device of FIG. 1 and FIG. 4 to identify a client device to operate as a local orchestrator when the orchestrator of FIG. 1 and FIG. 2 is disabled.

FIG. 12 is a flowchart representative of example machine readable instructions that may be executed by the first example client device of FIG. 1 and FIG. 4 to operate as a local orchestrator until communication with the example remote orchestrator of FIG. 1 and FIG. 2 can be reestablished.

FIG. 13 is a block diagram of an example processing system that may execute the example machine readable instructions of FIGS. 5, 6, 7, 8, 9, 10, 11 and/or 12 to implement the example orchestrator of FIG. 1 and FIG. 2 and/or the first example client device of FIG. 1 and FIG. 4.

The figures are not to scale. Wherever possible, the same reference numbers will be used throughout the drawing(s) and accompanying written description to refer to the same or like parts.

### DETAILED DESCRIPTION

Personal mobile devices are commonly used by consumers to access media, data content, video content, audio content, etc. In some cases, the content to be accessed is stored in its entirety on the mobile device on which the content is downloaded from a content service provider. In other cases, the content being accessed is stored on a local storage device of a LAN to which the mobile device is communicatively coupled. In yet other cases, the content is stored on a remote storage device accessed by the personal mobile device via, for example, wireless cellular technology, near range wireless technology (e.g., bluetooth) and/or wired communication technology (e.g., a digital subscriber line). Such a remote storage device may include a cloud storage device. However, when any such personal mobile device and LAN storage device configured to store content in this manner experiences a failure event, the content stored thereon can be lost and, in many cases, cannot be recovered. Further, content stored on a personal mobile device that communicates with other electronic devices via a LAN can be accessed by the other electronic devices only when the personal mobile device is communicatively coupled with the LAN. For example, a user may operate a first LAN associated with a first location (e.g., the user's home), a second LAN associated with a second location (e.g., the user's automobile) and a third LAN associated with a third location (e.g., the user's office/work location). In such a configuration, content stored on the personal mobile device (e.g., a smart phone) may be accessed via a device coupled to the automobile-based LAN only when the personal mobile device is coupled to the automobile based-LAN. If the content is stored on a remote storage device (e.g., a cloud storage device), the user may access the content via the mobile phone or other network device but perhaps at significant cloud-access cost (e.g., cloud service fee). Further, the accessibility of the content stored in the cloud is dependent on the availability of wireless communication service (e.g., cellular telephone service) which is limited in some geographical areas.

In contrast to such prior content access and storage techniques, example methods, apparatus and articles of manufacture disclosed herein enable content to be stored in a distributed manner among multiple client devices of a LAN. In some examples, the content is encoded into a set of different content shares and the different content shares are distributed according to a distributed content share storage scheme (also referred to as a content share storage scheme) among the client devices of the LAN. In some examples, erasure encoding is used to encode the shares such that only a subset of the total number of different content shares included in the set of different content shares are needed to recover the content. The subset includes a threshold number of the different content shares. The threshold number is less than the total number of different content shares and is the minimum number of different content shares required to recover/reconstruct the content for access. In some examples, a combination having a threshold number of the different content shares is determined and a first subset of the combination is stored on a first client device of the LAN and a second subset is stored on a second client device of the LAN. As a result, the content is accessible to any of the client devices coupled to the network by collecting the first subset of the combination from the first device and the second subset of the combination from the second device without need to access all of the shares of the encoded content. By distributing the different content shares across multiple client devices, the failure of any single device will not result in the loss of content provided that at least a threshold number of the different content shares (e.g., the first and second subsets of the combination of different content shares) can be recovered from the other client devices coupled to the LAN.

Example methods, apparatus and articles of manufacture disclosed herein include an orchestrator that generates a content share storage scheme that identifies different, encoded content shares of a content file and the network client devices to which the different content shares are to be distributed. The orchestrator supplies the content share storage scheme to a client device which uses the content share storage scheme to distribute the shares. When a client device subsequently attempts to access the content, the orchestrator supplies the content accessing client device with information from the content share storage scheme identifying the client devices on which the corresponding content shares are stored.

In some examples, the orchestrator is implemented in a remote storage device (e.g., a cloud storage device). The content share storage scheme is stored in the cloud and the content shares are stored on the client devices so that when the content is accessed by any of the client devices, the accessing client device need only access the cloud to obtain the content share storage scheme, not the content itself. As a result, the content-accessing client device only accesses the cloud for an amount of time needed to obtain the content share storage scheme, thereby reducing the cloud access time and access costs. In addition, as described above, storing the shares on multiple devices coupled to the network eliminates the single point of failure that exists in content storage systems having content stored on a single network device.

An example orchestrator disclosed herein is further able to generate content share storage schemes for client devices associated with different networks. In some examples, the networks are each associated with a different geographical location and/or a different LAN switch. Such networks can include, for example, a first network associated with a user's home, a second network associated with the user's automobile, and/or a third network associated with the user's place of employment. In some examples, a first network device attempts to access content that was previously encoded into shares that are stored on other network devices. The content-accessing first client device notifies the orchestrator of the access attempt and the orchestrator responds with information identifying a combination of the different content shares comprising a threshold number of shares. The information supplied by the orchestrator further identifies client devices at which subsets of the combination of different content shares are stored. For example, a first subset may be stored on the content-accessing first client device and a second subset may be stored on a second client device. In some examples, the combination may include three subsets, each of which is stored on a different client device. In some examples, the content-accessing first client device uses the supplied information to collect the identified subsets of the combination of different content shares and recovers/reconstructs the content using the different content shares included in each subset. Recovering/reconstructing content using a combination of different content shares involves restoring the encoded content back to its original, pre-encoded form such that the content is viewable/accessible to a user via an electronic device. In some examples, the content shares are encrypted and decrypted using an encryption key accessible to one or more of the client devices.

In some of the example methods, apparatus and articles of manufacture disclosed herein a second orchestrator is implemented in a mobile device or other electronic device associated with one or more of the networks and is used when access to the orchestrator implemented in the cloud is unavailable to the user (e.g., wireless access to the cloud is disabled due to, for example, lack of cellular communication service coverage). As described in greater detail below, the personal mobile device(s) and other electronic network devices can include any type of device having access to one or more of the networks including a smartphone or other mobile phone, a personal digital assistant (PDA), a tablet computer, an e-reader, a wireless access point, a cable/satellite modem, a personal computer, a data storage device, etc. Thus, mobile distributed storage networks disclosed herein enable distributed storage of content among multiple network devices (including mobile devices) to improve the availability of content, to reduce the time required to access the content, to reduce costs associated with accessing a cloud storage service, and/or to eliminate content/data loss due to failure of one or more of the network devices.

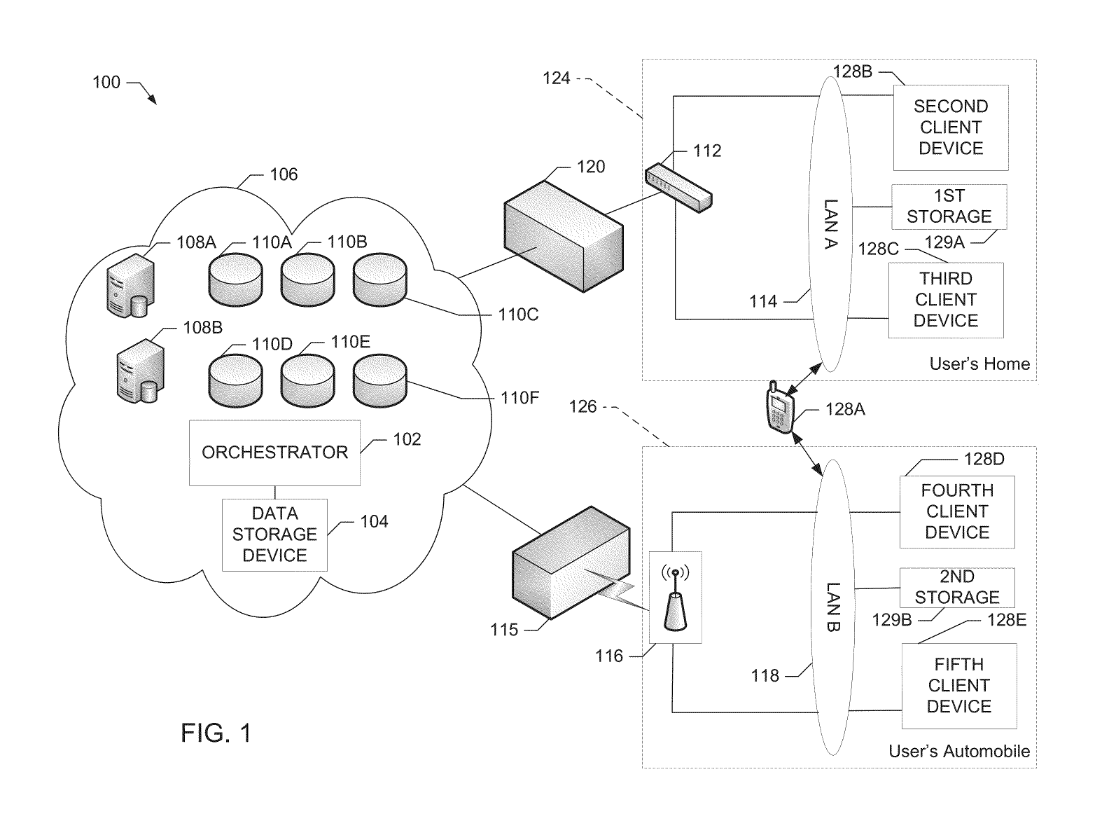

Turning to the figures, FIG. 1 is a block diagram of an example distributed storage network 100. The mobile distributed storage network 100 of the illustrated example includes an example orchestrator 102 and an example data storage device 104 implemented in an example cloud processing/storage environment 106 having one or more processors 108A, 108B and one or more data storage devices 110A, 110B, 110C, 110D, 110E, 110F. The orchestrator 102 communicates with an example first switch (“LAN A switch”) 112 that implements a first local area network (“LAN A”) 114, and an example second switch (“LAN B switch”) 116 that implements a second local area network (“LAN B”) 118 via a first access network 120 and a second access network 122, respectively. The LAN A switch 112 and/or the LAN B switch 116 may be configured to communicate via wired or wireless communication with the first access network 120 and the second access network 122, respectively, and both the LAN A and LAN B switches 112, 116 may correspond to any type of LAN switch, bridge, router, etc. In the illustrated example, the LAN A 114 is implemented at a first location 124 associated with a user (e.g., the user's home 124) and the LAN B 118 is implemented at a second location 126 associated with a user (e.g., the user's automobile, the user's place of employment, etc.). In some examples, the first access network 120 and the second access network 122 are a same access network. In some examples, the LAN A switch 112 and/or the LAN B switch 116 are communicatively coupled to a plurality of access networks.

In some examples, the example system 100 of FIG. 1 includes any number of electronic devices configured to execute client software applications (e.g., a first example client device 128A, a second example client device 128B, a third example client device 128C, a fourth example client device 128D, a fifth example client device 128E, etc.). In some examples, the system 100 includes a first storage device 129A coupled to the LAN A 114 and a second storage device 129B coupled to the LAN B 118.

In some examples, the first example client device 128A can be implemented as a mobile phone (e.g., a smart phone, a cellular phone, a satellite phone, etc.) and communicatively couples to the LAN A 114 when within communication range of the LAN A switch 112 and communicatively couples to the LAN B 118 when within communication range of the LAN B switch 116. In addition, any number of client devices (e.g., the second example client device 128B, the third example client device 128C, etc.) are communicatively coupled to the LAN A 114 and any number of client devices (e.g., the fourth example client device 128D, the fifth example client device 128E, etc.) are communicatively coupled to the LAN B 116. In some examples, the second client device 128B, the third client device 128C, the fourth client device 128D and the fifth client device 128E are implemented by any of a portable computer (such as a laptop computer, a notebook computer, a tablet computer, etc.), a personal data device (such as a PDA, an e-reader, etc.), a digital camera (which may be embedded in, for example, a mobile phone), a computer (such as a personal computer, a server, etc.), etc. The second client device 128B and third client device 128C are coupled to the LAN A switch 112 via any type(s) of communication link(s), such as one or more cabled links (such as Ethernet links and/or USB links), one or more wireless links (such as Wi-Fi links and/or Bluetooth links), etc. Likewise, the fourth client device 128D, and fifth client device 128E are coupled to the LAN B switch 116 via any type(s) of communication link(s), such as one or more cabled links (such as Ethernet links and/or USB links), one or more wireless links (such as Wi-Fi links and/or Bluetooth links), etc.

In some examples, any of the second client device 128B, the third client device 128C, the fourth client device 128D and/or the fifth client devices 128E can also communicatively couple to the LAN A 114 and to the LAN B 118 when within range of the corresponding one of the LAN A switch 112 and the LAN B switch 116, respectively. In some examples, the fourth client device 128D and the fifth client device 128E can be built into the user's automobile 126. Likewise, any other type of content/data access and processing device can be built into the user's automobile 126 and communicatively coupled to the LAN B 118. In some examples, the wireless LAN B switch 116 can be built into the user's automobile 126 and can be implemented to include a Wi-Fi receiver, a mobile hotspot, etc.

In some examples, the first example client device 128A, the second example client device 128B, the third example client device 128C, the fourth example client device 128D, the fifth example client device 128E, etc., are configured to use encoding technique(s) to encode data content files (also referred to as “content” and/or “content files”) into a total number of different content shares. The content file(s) can contain video content, image content, audio content, etc. In some examples, the content file(s) are downloaded from a content provider via from one of the access networks 120, 122.

In some examples, the encoding technique(s) used by the first example client device 128A to encode the content into different content shares include erasure encoding technique(s). Using an erasure encoding technique, the content is encoded into a set of content shares including a total number of different content shares. The encoded content can be reconstructed/recovered using a combination of a threshold number of the different content shares. In some examples, a first content file named “IMAGE” contains image data and can be encoded into many (e.g., a total of five) different content shares (e.g., ISH0, ISH1, ISH2, ISH3, ISH4) having a threshold number (e.g., two). Thus, any of a plurality of combinations comprising two of the five different content shares (e.g., ISH0, ISH1, ISH2, ISH3, ISH4) can later be used to reconstruct/recover the IMAGE content file of the above example (i.e., 5 shares threshold 2). The combinations of different content shares used to reconstruct the IMAGE content file can be formed using a first subset of shares that includes any one of the content shares and a second subset includes any one of the other content shares, provided that the content share in the first subset and the content share in the second subset are different content shares. TABLE I provided below illustrates three such example share combinations that can be used to reconstruct/recover the IMAGE content file. The first combination includes a first subset having the share ISH0, and a second subset having the share ISH1. A first subset of the second combination includes the share ISH0 and a second subset includes the share ISH2. A first subset of the third combination includes the share ISH3 and a second subset includes the share ISH4. The example share combinations illustrated in TABLE I represent only three of a plurality of combinations of different content shares that can be used to reconstruct the IMAGE content file.

TABLE I

| | | |
|---|---|---|
| First | Subset 1 | ISH0 |
| combination | Subset 2 | ISH1 |
| Second | Subset 1 | ISH0 |
| combination | Subset 2 | ISH2 |
| Third | Subset 1 | ISH3 |
| combination | Subset 2 | ISH4 |

By way of further example, as illustrated in TABLE II below, a second example content file named “VIDEO” contains video data and can be encoded into several (e.g., seven) example different content shares (e.g., VSH0, VSH1, VSH2, VSH3, VSH4, VSH5, VSH6). In this example, a threshold number of three different content shares are needed to reconstruct/recover the VIDEO content file. In some examples, the VIDEO content file can be reconstructed/recovered using a first combination having a first subset containing the content shares VSH0, VSH1 and a second subset containing the content share VSH4. The VIDEO content file can also be reconstructed using a second combination having a first subset containing the content share VSH0, a second subset containing the content share VSH1 and a third subset containing content share VSH4. The two example combinations illustrated in TABLE II represent two of a plurality of combinations of different content shares that can be used to reconstruct the VIDEO content file.

TABLE II

| | | |
|---|---|---|
| First | Subset 1 | VSH0, VSH1 |
| Combination | Subset 2 | VSH4 |
| Second | Subset 1 | VSH0 |
| Combination | Subset 2 | VSH1 |
| | Subset 3 | VSH4 |

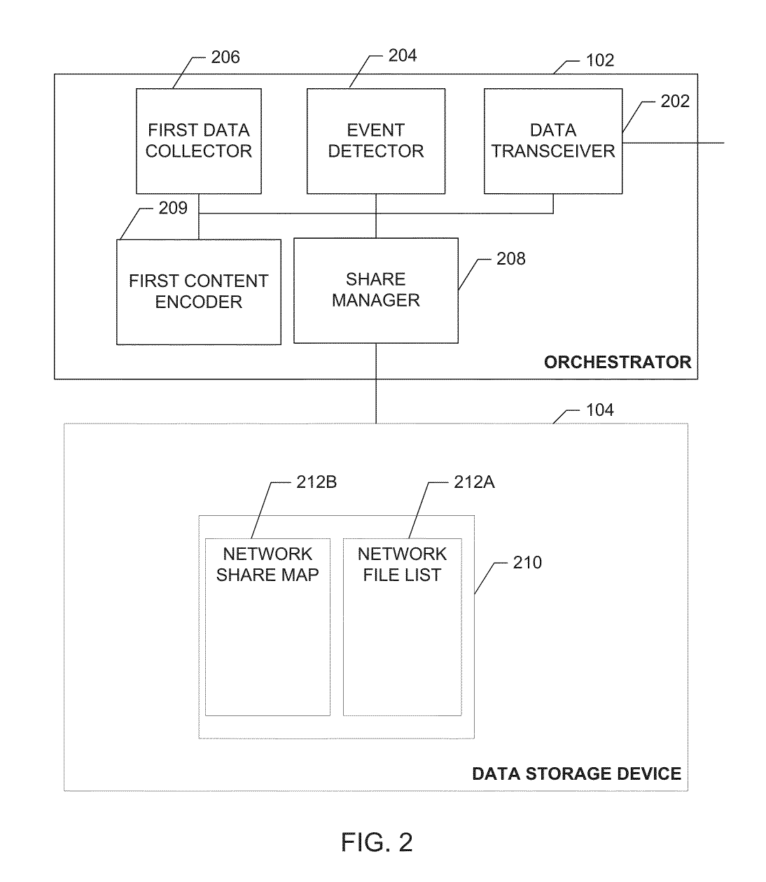

Referring to FIG. 1 and FIG. 2, FIG. 2 is a block diagram 200 of example implementations of the example orchestrator 102 and example data storage device 104 shown in FIG. 1. In the illustrated example of FIG. 2, the orchestrator 102 includes a data transceiver 202 by which the orchestrator 102 communicates with the first example client device 128A, the second example client device 128B, the example third client device 128C, the fourth example client device 128D and the fifth example client device 128E. An example event detector 204 detects when content is downloaded and/or accessed at any of the first client device 128A, the second client device 128B, the third client device 128C, the fourth client device 128D and/or the fifth client device 128E (see FIG. 1). In some examples, the event detector 204 detects a content download event involving the download of a content file (e.g., the IMAGE content file) at the first client device 128A when the first client device 128A is coupled to the LAN A 114. The content download can be detected via a notification signal sent by the first client device 128A to the example data transceiver 202 of the example orchestrator 102.

In response to detecting the content download event, the example event detector 204 causes a first example data collector 206 to collect example network/share information. As illustrated in TABLE III, the network/share information can include: 1) a network identifier identifying a network (e.g., the LAN A 114) to which the content-downloading device (e.g., the first client device 128A) is coupled, 2) information identifying the content-downloading device (e.g., the first client device 128A), 3) client device identifiers identifying the other client devices (e.g., the second client device 128B and the third client device 128C) coupled to the identified network (e.g., LAN A 114), 4) content file information identifying the name of the downloaded content file (e.g., IMAGE), 5) information identifying a total number (e.g., five) of content shares into which the downloaded content (e.g., the IMAGE content file) has been encoded, 6) information identifying the threshold number (e.g., three) of different content shares required to reconstruct/recover the content file (e.g., the IMAGE content file), 7) content share identifying information (e.g., ISH0, ISH1, ISH2, ISH3, ISH4), 8) an amount of share storage capacity (e.g., 20 shares) available at each client device (e.g., the first client device 128A, the second client device 128B, the third client device 128C) coupled to the identified network (e.g., the LAN A 114), etc. The network/share information is subsequently transmitted (or otherwise made available) to an example share manager 208 for use in generating a corresponding content share storage scheme 210 indicating how the content shares (e.g., ISH0, ISH1, ISH2, ISH3, ISH4) of the downloaded content (e.g., the IMAGE content file) are to be distributed among the client devices (e.g., the first client device 128A, the second client device 128B, the third client device 128C, etc.) of the LAN A 114. In some examples, the storage capacity available at each client device is used to determine a number of shares that can be stored on the device.

TABLE III
IMAGE 1 Share/Network Information

| | |
|---|---|
| Network ID | LAN A |
| Content-Downloading Device | 1st client device |
| Client Devices | 2nd client device, 3^{rd} client device |
| Content Filename | IMAGE |
| Total # of Shares | 5 |
| Threshold # of Shares | 2 |
| Share Identifiers | ISH0, ISH1, ISH2, ISH3, ISH4 |
| 1^{st} client device share storage | 20 shares |
| capacity | |
| 2^{nd} client device share storage | 20 shares |
| capacity | |
| 3^{rd} client device share storage | 20 shares |
| capacity | |

The example share manager 208 of FIG. 2 causes the content share storage scheme 210 to be stored in the data storage device 104 and causes the content share storage scheme to be transmitted to the content-downloading device (e.g., the first client device 128A) for use in distributing the different content shares (e.g., ISH0, ISH1, ISH2, ISH3, ISH4) among one or more of the client devices (e.g., the first client device 128A, the second client device 128B and/or the third client device 128C) coupled to the network (e.g., LAN A 114). The distributed content shares can then be retrieved from one or more of the client devices (e.g., the first client device 128A and the second client device 128B) coupled to the network (e.g., the LAN A 114) to form a share combination(s) that can be used to reconstruct/recover a corresponding content file(s).

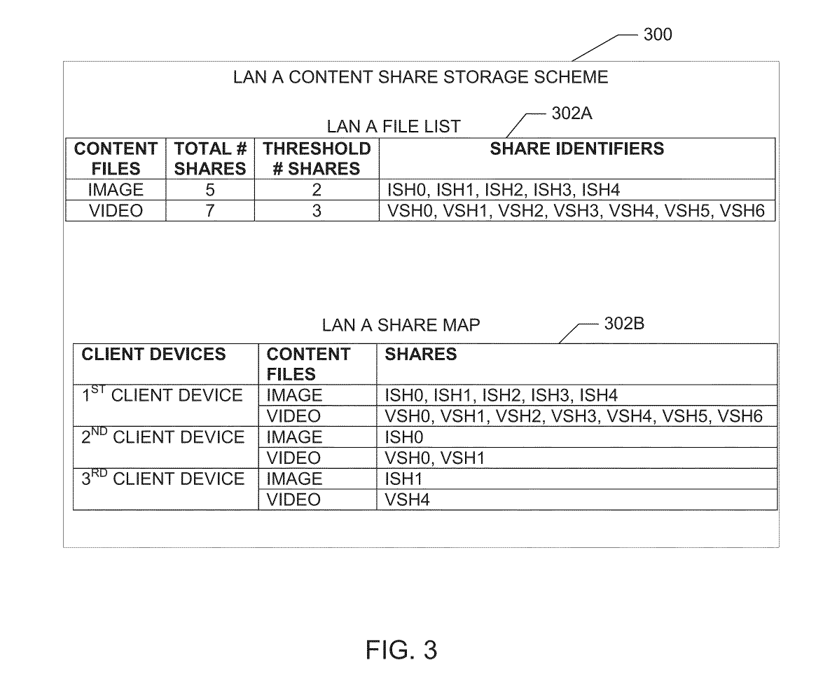

The example content share storage scheme 210 (see FIG. 2) can be formatted and stored as an example network file list 212A and an example network share map 212B. One such example content share storage scheme 300 provided in FIG. 3 illustrates a manner in which content file shares (e.g., the IMAGE content shares and the VIDEO content shares) are to be distributed among the first client device 128A, the second client device 128B and/or the third client device 128C of the LAN A 114. The example network file list 302A identifies: 1) the name(s) of the content file(s) (e.g., IMAGE and VIDEO) accessible to the client devices (e.g., the first client device 128A, the second client device 128B and the third client device 128C) coupled to a network (e.g., the LAN A 114), 2) the total number of content shares associated with each content file(s) (e.g., five total content shares for IMAGE and seven content shares for VIDEO), 3) a corresponding threshold number of content shares needed to reconstruct each content file (e.g., two threshold content shares for IMAGE and three threshold content shares for VIDEO)), 4) share identifying information (e.g., ISH0, ISH1, ISH2, ISH3, ISH4, VSH0, VSH1, VSH2, VSH3, VSH4, VSH5, VSH6, etc.) etc. The example network share map 302B lists: 1) the client devices (e.g., the first client device 128A, the second client device 128B, the third client device 128C, etc.) coupled to the network (e.g., the LAN A 114) 2) the names of the content files (e.g., IMAGE and VIDEO), 3) information identifying the content shares to be distributed to each of the example client devices, etc.

The example network share map 302B illustrated in FIG. 3 indicates that the IMAGE content share ISH0 (or a copy thereof) is to be distributed to the second example client device 128B and the IMAGE content share ISH1 (or a copy thereof) is to be distributed to the third example client 128C. In addition, all of the IMAGE content shares (e.g., ISH0, ISH1, ISH2, ISH3, ISH4), or a copy thereof, are to be retained on the first client device 128A. As is described in greater detail below, when the first client device 128A subsequently couples to another of the LANs (e.g., the LAN B 118), the content shares of the IMAGE content file can be distributed to the client devices (e.g., to the fourth client device 128D and/or the fifth client device 128E, etc.) coupled to the LAN (e.g., the LAN B) in accordance with another content share storage scheme created by the orchestrator 102. Storage of the IMAGE content shares on the client devices of the second network (e.g., the LAN B) renders the IMAGE content file accessible to the client devices coupled to the second network.

The example network share map 302B also indicates that the VIDEO content shares VSH0 and VSH1 (or a copy(ies) thereof) are to be distributed to the second example client device 128B and the VIDEO content share VSH4 (or a copy thereof) is to be distributed to the third example client 128C. In addition, all of the VIDEO content shares (e.g., VSH0, VSH1, VSH2, VSH3, VSH4), or a copy thereof, are to be retained on the first client device 128A. When the first client device 128A subsequently couples to another of the LANs (e.g., the LAN B 118), the content shares of the VIDEO content file can be distributed to the client devices (e.g., the fourth client device 128D and/or the fifth client device 128E, etc.) coupled to the LAN (e.g., the LAN B) in accordance with another content share storage scheme created by the orchestrator 102. Storage of the VIDEO content shares on the client devices of the second network (e.g., the LAN B) renders the VIDEO content file accessible to the client devices coupled to the second network (e.g., the LAN B 118).

In some examples, the orchestrator 102 additionally includes a first encoder 209 that can encode content delivered by any of the client devices (e.g., the first client device 128A, the second client device 128B, the third client device 128C, etc.). The first encoder 209 can encode the content (e.g., IMAGE, VIDEO, etc.) into a plurality of content shares, create a corresponding share storage scheme and transmit the share storage scheme and shares to the content delivering device for distribution among the other client devices in accordance with the corresponding share storage scheme. Such example systems can be used, for example, when the client device at which the content is downloaded does not have sufficient processing power to perform the content encoding. In some examples, instead of locating the first encoder 209 in the orchestrator 102, the first encoder 209 can be co-located with the orchestrator (e.g., located in the cloud 106) and communicatively coupled to the orchestrator 102.

Referring still to FIG. 2 and FIG. 3, when any of the client devices (e.g., the first example client device 128A, the second example client device 128B, the third example client device 128C, the fourth example client device 128D, the fifth example client device 128E) attempts to access a content file (e.g., the IMAGE content file or the VIDEO content file) having content shares distributed among one or more of the client devices, the example event detector 204 receives an example access event notification. The access event notification can include information identifying which of the client devices is attempting the content access and indicating the name of the content file being accessed. The event detector 204 notifies the first example data collector 206 that the access event notification has been received causing the first data collector 206 to collect network information identifying: 1) the name of the content file being accessed, 2) the network to which the client device attempting the content access is coupled; 3) the name of the client device attempting the content access, 4) other client devices coupled to the identified network, etc.

In some examples, the example share manager 208 uses the collected network information to retrieve, from the example data storage device 104, a content share storage scheme corresponding to the identified network. The share manager 208 uses the retrieved content share storage scheme to identify combinations of different content shares that can be used to recover/reconstruct the content file being accessed. For example, when the first client device 128A attempts to access the IMAGE content file while coupled to the LAN A 114, the share manager 208 uses the example content share storage scheme 300 illustrated in FIG. 3 to determine that two different content shares are needed to reconstruct the IMAGE content file and that IMAGE shares ISH0, ISH1, ISH2, ISH3, ISH4 are stored on the first client device 128A, the IMAGE share ISH0 is stored on the second content device 128B, and the IMAGE share ISH1 is stored on the third client device 128C.

Thus, when the second example client device 128B attempts to access the IMAGE content file, the example share manager 208 consults the share storage scheme 300 to determine that a combination of content shares including the IMAGE content shares ISH0 and ISH1 can be used to reconstruct the IMAGE content file. Because the content share storage scheme 300 indicates that the IMAGE share ISH0 is already stored on the second client device 128B, the second client device 128 B need only obtain the IMAGE content share ISH1 from the third example client device 128C to access and reconstruct the IMAGE content file. Additional combinations that can be used to reconstruct the IMAGE content file also include the IMAGE content share ISH0 stored on the second client device 128A and one of any of the IMAGE content shares ISH1, ISH2, ISH3 or ISH4 stored on the first client device 128A.

Likewise, when the third client device 128C attempts to access the IMAGE content file, the example share manager 208 determines that the IMAGE share ISH1 is already stored on the third client device 128C such that the third client device 128C need only obtain the IMAGE share ISH0 from the second client device 128B to access and reconstruct the IMAGE content file. Additional combinations that can be used by the third client device 128C to reconstruct the IMAGE content file include the IMAGE share ISH1 stored on the third client device 128C and any one of the shares ISH0, ISH2, ISH3 or ISH4 stored on the first client device 128C.

The example share manager 208 of FIG. 2 supplies the content-accessing device with information identifying a combination of shares to be used to reconstruct the accessed content and identifying the client devices on which the shares included in the combination are stored. In some examples, when content reconstruction/recovery is unsuccessful using the combination of shares identified in the message supplied by the orchestrator 102 to the content accessing network device, the share manager 208 uses the content share storage scheme information to generate a second combination of shares. The share manager 208 sends information identifying the second combination of shares to the content-accessing client device for use in collecting the shares and reconstructing/recovering the corresponding content file. A content recovery/reconstruction effort may be unsuccessful for any of a variety of reasons including 1) share(s) included in a combination is/are no longer present on an identified client device, 2) the share(s) included in a combination is/are corrupted, 3) the client device on which a share included in the combination is/are stored has/have become decoupled from the network, etc.

In some examples, the share manager 208 transmits all or a subset of the content share storage scheme to the content-accessing client device and the content-accessing client device determines a combination of content shares that can be used to reconstruct/recover the content being accessed.

In some examples, when a client device retrieves and uses a combination of shares identified by the share manager 208 to access a content file, the content-accessing client device retains the retrieved shares to use when accessing the content at a later time(s). The share manger 208 updates the associated content share storage scheme to reflect the retention of the content shares on the content-accessing client device.

At any time, the share manager 208 of the orchestrator 102 can determine that an existing share storage scheme corresponding to a content needs to be re-generated because, for example, one or more of the client devices associated with a network are no longer associated with the network, one or more new client devices are associated with the network, etc. In some such examples, the share manager 208 will generate a new share storage scheme corresponding to the content and perform the operations described above, as needed, to cause the content shares to be re-encoded and redistributed, as needed, in accordance with the new share storage scheme.

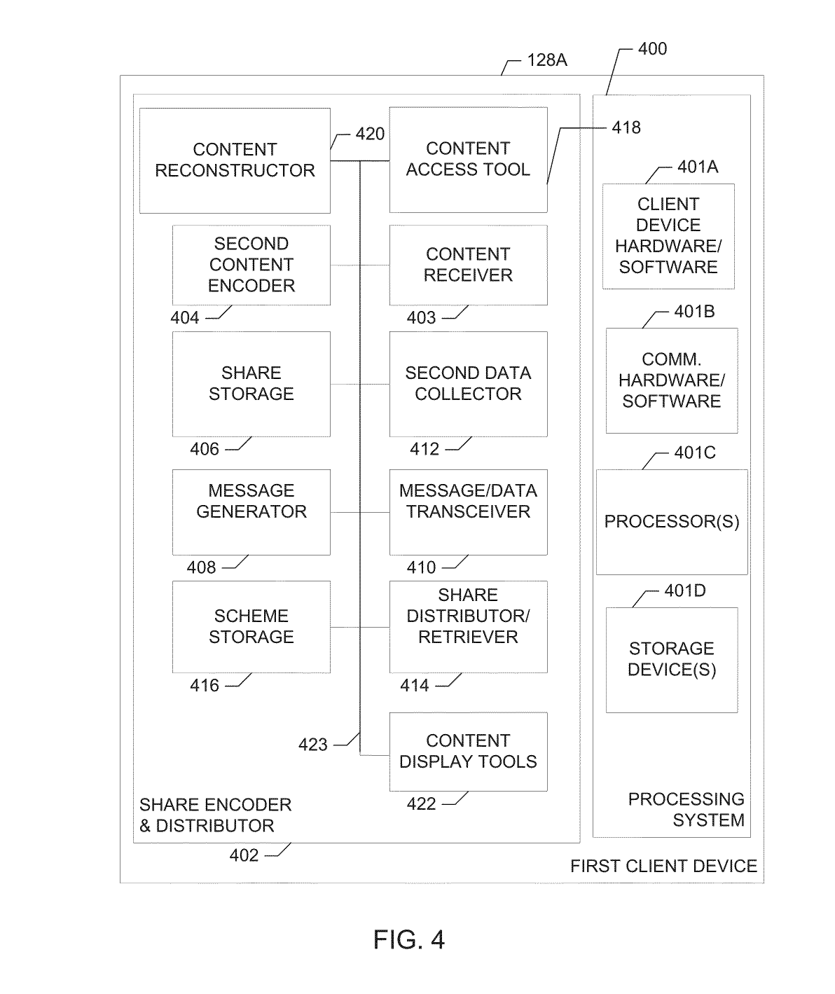

FIG. 4 is a block diagram of an example implementation of the example first client device 128A of FIG. 1. Although the block diagram 400 of FIG. 4 is described as being an implementation of the first client device 128A, the same block diagram can be used to represent any of the client devices (e.g., the second client device 128B, the third client device 128C, the fourth client device 128D and/or the fifth client device 128E). The first client device 128A includes an example processing system 400 that can include example client software/hardware 401A for executing client applications, example communication software/hardware for communicating with the LAN A 114 and the client devices coupled thereto (e.g., the second client device, the third client device, etc.), an example processor(s), an example storage device(s), etc. The client software/hardware 401A, the communication software/hardware, the processor(s), and the storage device(s) can be communicatively and/or physically coupled in any configuration and/or can be coupled to an example share encoder and distributor 402 and/or the components associated therewith (described below) in any manner.

When the example first client device 128A detects the download of a content file at a content receiver 403, an example second content encoder 404 uses an encoding key to encode the content file into a total number of different content shares and causes the different content shares to be deposited in a share storage 406. In some examples, the encoding key is stored on any or all of the client devices (e.g., the first client device 128A, the second client device 128B, the third client device 128C, the fourth client device 128D, the fifth client device 128E, etc.). In some examples, the encoding key is stored on only a subset of the client devices. In some such examples, before encoding a content file, the first client device 128A determines whether the encoding key is stored on the first client device 128A and, if not, polls one or more of the other client devices to determine where the encoding key is stored. Upon locating the encoding key, the first client device 128A obtains the key for usage in encoding the content. In some examples, the encoding key is only stored on one of the client devices such that content can only be encoded/decoded when the client device having the key is accessible to the client devices.

The first client device 128A notifies the example orchestrator 102 (see FIG. 1 and FIG. 2) that the content has been downloaded via a notification inserted by an example message generator 408 into a message to be transmitted to the orchestrator 102 via an example message/data transceiver 410. In some examples, the orchestrator 102 periodically or aperiodically polls the first client device 128A to determine whether any new content has been downloaded in the time intervening between a current poll and an earlier poll. In response to such a poll, the first client device 128A notifies the orchestrator 102 of any such newly downloaded content.

In addition to notifying the example orchestrator 102 that the content has been downloaded, the example second data collector 412 collects network information (e.g., the identity of the network to which the mobile network device is currently coupled, the identities of the other network devices coupled to the identified network and the storage capacity associated with the other network devices) and collects available storage capacity information from each client device coupled to the network. In some examples, the second data collector 412 collects the information by communicating with the other network devices coupled to the identified network. The message generator 408 transmits the collected network information to the orchestrator 102 via the message/data transceiver 410. The message created by the message generator 408 can additionally include share-related information (e.g., the total number of different content shares, the threshold number of different content shares needed to reconstruct the content file, the sizes of the different content shares, share identifying information, etc.) stored in the share storage.

In response to the message containing the network/share information, the orchestrator 102 supplies a responsive message to the first example client device 128A containing the corresponding content share storage scheme indicating the manner in which the content shares are to be distributed among the client devices coupled to the network, as described above. The example share distributor/receiver 414 of the first client device 128A distributes the content shares to the client devices coupled to the identified network in accordance with the received content share storage scheme. In some examples, the received content share storage scheme can be stored in a scheme storage device 416 on the first client device 128A for later use in identifying where the distributed content shares are stored. Because the distribution of storage shares may change over time due to activities/events related to the client devices coupled to the network, the content share storage scheme information stored in the first client device 128A can become unreliable/stale over time. In some examples, to avoid the potential of using stale share storage information, the first client device 128A is configured to consult the share storage scheme information stored in the scheme storage 416 only when communication with the orchestrator 102 is unsuccessful.

In some examples, the scheme storage 416 and the share storage 406 are a same storage device. In some examples, the example share distributor 414 of the content-downloading client device distributes the content shares to the client devices coupled to the network at or near the time that the content share storage scheme is received at the first client device 128A. In some examples, the share distributor 414 distributes shares to the client devices associated with (but not currently coupled to) the network at a subsequent time when the client devices become coupled to the network.

In some examples, when an example content access tool 418 of the first client device 128A attempts to access previously downloaded content, the message generator 408 inserts a content access notification into a message and supplies the message to the message/data transceiver 410 for delivery to the orchestrator 102 (see FIG. 1). In some examples, the content access tool 418 identifies the name of the content file being accessed and the example second data collector 412 identifies 1) the network to which the mobile network device is currently coupled, and 2) the other network devices coupled to the identified network at the time of content access.

The information collected by the content access tool 418 and the example second data collector 412 is supplied to the orchestrator 102 in a message transmitted via the message/data transceiver 414. In some examples, the first client device 128A receives a responsive message from the orchestrator 102 identifying a combination of a threshold number of different content shares associated with the accessed content and further identifying the other client devices on which the different content shares of the combination are stored. In some examples, the identified combination includes a plurality of subsets, each subset having one or more content shares and each subset being stored on one or more of the client devices coupled to the network. The example share distributor/retriever 414 of the content-accessing client device collects the identified combination of different content shares from the client devices identified by the orchestrator 102. If the combination of content shares is successfully retrieved, an example content reconstructor 420 uses the retrieved content shares to reconstruct the content and supplies the reconstructed content to one or more example content display tools 422. If the content shares are not successfully retrieved (e.g., one or more of the network devices that are identified as storing a different share associated with the combination no longer has the different share in storage, or the stored share is corrupted, or the network device storing the content share has decoupled from the network before the share could be retrieved), the share distributor/retriever 414 notifies the message generator 408 which creates a message indicating that a second combination of different content shares is needed to perform content reconstruction. The message containing the request for a second share combination is transmitted to the orchestrator 102 via the message/data transceiver 414. The orchestrator 102 responds by transmitting information identifying a second combination of different content shares that can be used by the content-accessing client device to reconstruct the content.

In some examples, the client device (e.g., the second client device 128B) attempting to access content is unable to communicate with the orchestrator 102 (see FIG. 1). When such communication is unsuccessful, one or more of the client devices (e.g., the first client device 128A) can be configured to operate as a local orchestrator. The local orchestrator (e.g., the first client device) is configured with one or more of the blocks associated with the remote orchestrator 102 of FIG. 2 and performs the storage scheme generating operations typically performed by the remote orchestrator 102, as described above. For example, the temporary, local orchestrator can create a content share storage scheme for newly downloaded content for use in distributing the content shares of the newly downloaded content among the client devices coupled to the LAN A 114 and/or the LAN B 118. The temporary, local orchestrator (e.g., the first client device 128A) can also save the created share content storage scheme and use it to identify share combinations that can be used by client devices attempting to access the newly downloaded content. In the meantime, the temporary, local orchestrator (e.g., the first client device 128A) repeatedly attempts to re-establish communication with the remote orchestrator 102. When such communication is re-established, the temporary local orchestrator (e.g., the first client device 128A) uploads any newly created/collected content share storage scheme information to the remote orchestrator 102. After the content share storage scheme information stored at the temporary, local orchestrator (e.g., the first client device 128A) has been synchronized with the content share storage scheme information stored at the remote orchestrator, the temporary, local orchestrator ceases operating as a local orchestrator.

As described above, in some examples, the content downloaded at one of the example client devices (e.g., the first client device 128A) coupled to an example first network (e.g., the LAN A 114) is encoded into content shares and the shares are subsequently distributed by the first client device 128A to the other example client devices (e.g., the second client device 128B and the third client device 128C) coupled to the LAN A 114. The shares are distributed in accordance with a content share storage scheme created by the orchestrator 102. If the first client device 128A subsequently couples to a second network (e.g., the LAN B 118), the orchestrator 102 is notified of the coupling and determines whether the encoded content shares have been distributed to the client devices (e.g., the fourth client device 128D and the fifth client device 128E) coupled to the LAN B 118. If so, then the orchestrator 102 takes no further actions to distribute the encoded content shares. If not, the orchestrator 102 generates a content share storage scheme by which the content shares are to be distributed to the fourth client device 128D and the fifth client device 128E and supplies the content share storage scheme to the first client device 128A for use in distributing the content shares.

In some examples, the example orchestrator 102 determines that one or more shares previously stored on a client device coupled to a network have been deleted, degraded or otherwise corrupted. When this occurs, the orchestrator 102 can use a corresponding, previously-generated share storage scheme in the data storage device 104 to identify other client devices coupled to the first network and the content shares stored on each such client devices. The share manager 208 uses information collected from the corresponding, previously-generated share storage scheme to generate a message instructing the client device associated with the deleted, degraded or otherwise corrupt content share(s) to delete such content shares (if applicable) and to collect/retrieve uncorrupted copies of the content shares (as identified in the content share storage scheme) from the other client devices coupled to the network. In some examples, the share manager 208 becomes aware of the corrupt/deleted content share(s) by periodically or aperiodically polling the client devices (e.g., the first client device 128A, the second client device 128B, the third client device 128C, etc.). In some examples, the share manager 208 becomes aware of the corrupt/deleted content share(s) when a share retrieval attempt by any of the client devices (e.g., the first client device 128A, the second client device 128B, the third client device 128C, etc.) attempting to access content is unsuccessful, etc. In some such examples when the share manager 208 determines that a share(s) stored on one or more of the client devices (e.g., the first client device 128A, the second client device 128B, the third client device 128C, etc.) the share manager 208 instructs a different one of the client devices (e.g., the first client device 128A, the second client device 128B, the third client device 128C, etc.) having an intact copy of the corrupt/deleted share to transmit the intact copy of that content share to the client device that needs the corrupt/deleted content share. In some examples, the share manager 208 instructs the client device associated with the corrupt/deleted content share to retrieve an intact copy of that content share from another client device that stores an intact copy of that content share.

In some examples, when none of the other client devices (e.g., the first client device 128A, the second client device 128B, the third client device 128C, etc.) coupled to the network have a copy of the corrupt/deleted content share, the share manager 208 can instruct the client device associated with the corrupt/deleted content share to retrieve a threshold number of the total content shares of the corresponding content from another of the client devices and to use the threshold number of content shares to reconstruct/retrieve the corresponding content. The share manager 208 can further instruct the client device to re-encode the reconstructed/retrieved to generate the total number of the encoded content shares corresponding to the content and to retain all of the newly encoded content shares or to retain only a copy of the newly encoded content share that was previously corrupt/deleted. In some examples, the threshold number of shares is retrieved from a storage device (e.g., the first storage device 129A, the second storage device 129B).

In some examples, the share manager 208 polls one or more of the client devices coupled to a network (or uses any other technique) to determine that one or more of the content shares previously distributed to one or more of the client storage devices are no longer present on the client device(s). The share manager can respond to the determination by instructing one (or more) of the client devices to perform the content reconstruction using a threshold number of the content shares, to re-encode the reconstructed content and to redistribute the content shares according to the corresponding previously-generated content share storage scheme or a newly-generated corresponding content share storage scheme. The share manager 208 updates the corresponding content share distribution scheme to reflect any changes to the content shares stored on any of the client devices resulting from the content share retrieval and/or distribution, and/or the content reconstruction operations described above.

In some examples, as shown in FIG. 4, the components associated with the example share encoder and distributor 402 is coupled via a communication bus 423. In some examples, the components of the share encoder and distributor 402 are coupled in any other desired configuration.

While an example manner of implementing the orchestrator 102 of FIG. 1 is illustrated in FIG. 2, one or more of the elements, processes and/or devices illustrated in FIG. 2 may be combined, divided, re-arranged, omitted, eliminated and/or implemented in any other way. Further, the example data transceiver 202, the example event detector 204, the example first data collector 206, the example share manager 208, the example first content encoder 209, the example data storage device 104 and/or, more generally, the example orchestrator 102 of FIG. 2 may be implemented by hardware, software, firmware and/or any combination of hardware, software and/or firmware. Thus, for example, any of the example data transceiver 202, the example event detector 204, the example first data collector 206, the example share manager 208, example first content encoder 209, the example data storage device 104 and/or, more generally, the example orchestrator 102 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data transceiver 202, the example event detector 204, the example first data collector 206, the example share manager 208, the example first content encoder 209, the example data storage device 104 and/or the example orchestrator 102 is/are hereby expressly defined to include a tangible computer readable storage device or storage disk such as a memory, a digital versatile disk (DVD), a compact disk (CD), a Blu-ray disk, etc. storing the software and/or firmware. Further still, the example orchestrator 102 of FIG. 1 may include one or more elements, processes and/or devices in addition to, or instead of, those illustrated in FIG. 2, and/or may include more than one of any or all of the illustrated elements, processes and devices.

Likewise, while an example manner of implementing the first example client device 128 of FIG. 1 is illustrated in FIG. 4, one or more of the elements, processes and/or devices illustrated in FIG. 4 may be combined, divided, re-arranged, omitted, eliminated and/or implemented in any other way. Further, the example share encoder and distributor 402, the example content receiver 403, the example second content encoder 404, the example share storage 406, the example message generator 408, the example message/data transceiver 410, the example second data collector 412, the example share distributor/retriever 414, the example scheme storage 416, the example content access tool 418, the example content reconstructor 420, the example content display tools 422, the example processing system 400, the example client device hardware/software 401A, the example communication hardware/software 401B, the example processor(s) 401C, the example storage devices 401D and/or, more generally, the first example client device 128A of FIG. 4 may be implemented by hardware, software, firmware and/or any combination of hardware, software and/or firmware. Thus, for example, any of the example share encoder and distributor 402, the example content receiver 403, the example second content encoder 404, the example share storage 406, the example message generator 408, the example message/data transceiver 410, the example second data collector 412, the example share distributor/retriever 414, the example scheme storage 416, the example content access tool 418, the example content reconstructor 420, the example content display tools 422, the example processing system 400, the example client device hardware/software 401A, the example communication hardware/software 401B, the example processor(s) 401C, the example storage devices 401D and/or, more generally, the first example client device 128A could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example share encoder and distributor 402, the example content receiver 403, the example second content encoder 404, the example share storage 406, the example message generator 408, the example message/data transceiver 410, the example second data collector 412, the example share distributor/retriever 414, the example scheme storage 416, the example content access tool 418, the example content reconstructor 420, the example content display tools 422, the example processing system 400, the example client device hardware/software 401A, the example communication hardware/software 401B, the example processor(s) 401C, and/or the example storage devices 401D is/are hereby expressly defined to include a tangible computer readable storage device or storage disk such as a memory, a digital versatile disk (DVD), a compact disk (CD), a Blu-ray disk, etc. storing the software and/or firmware. Further still, the first example client device 128A of FIG. 1 may include one or more elements, processes and/or devices in addition to, or instead of, those illustrated in FIG. 4, and/or may include more than one of any or all of the illustrated elements, processes and devices.

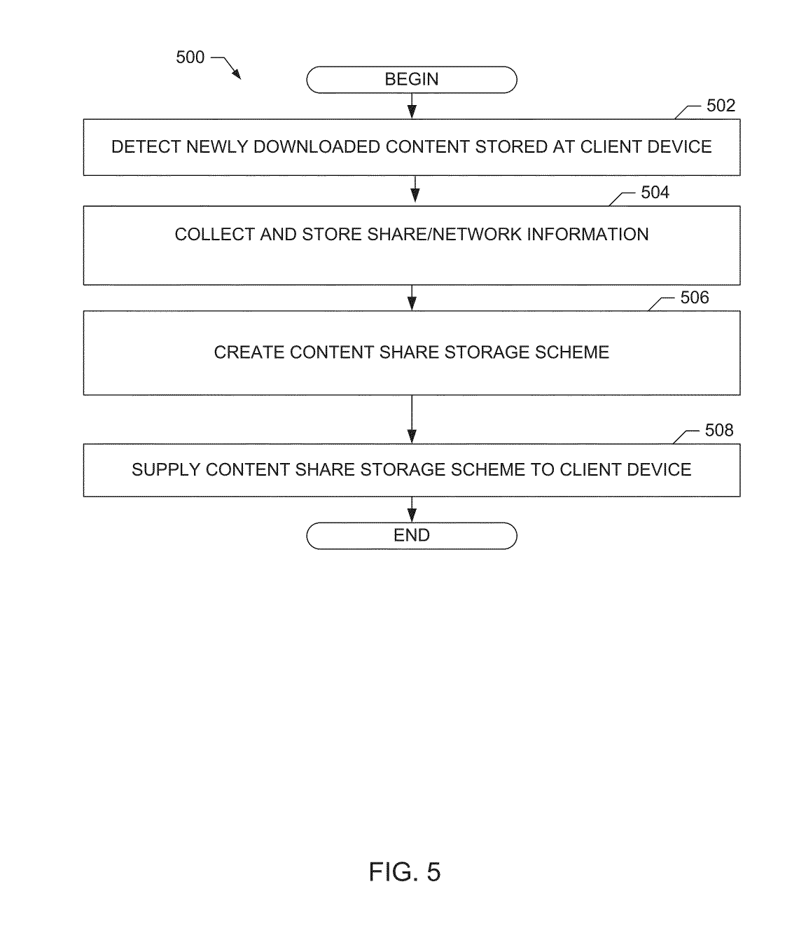

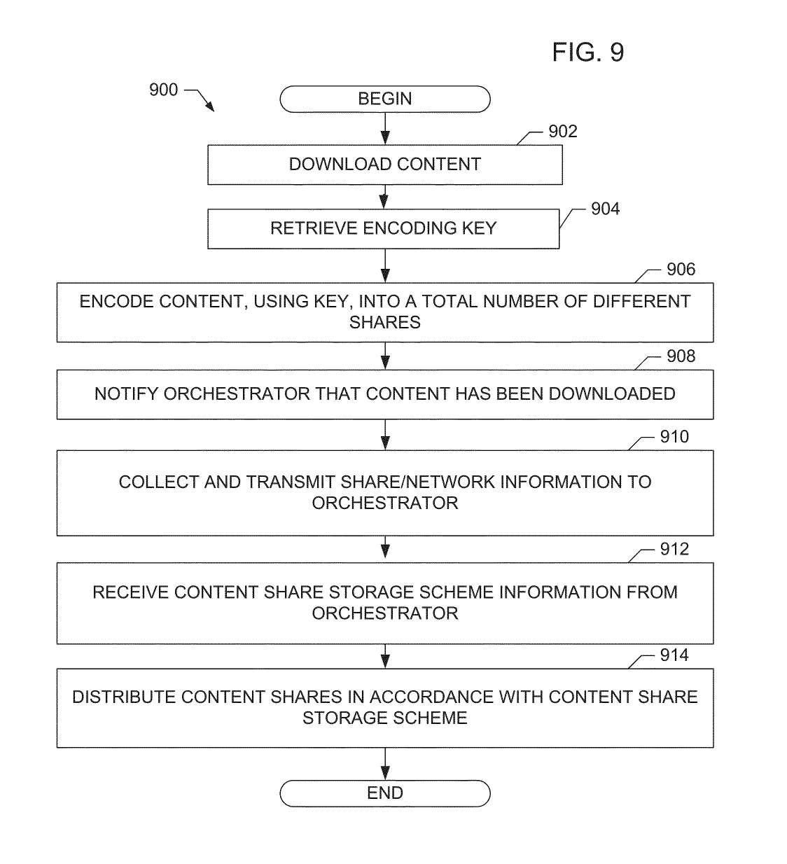

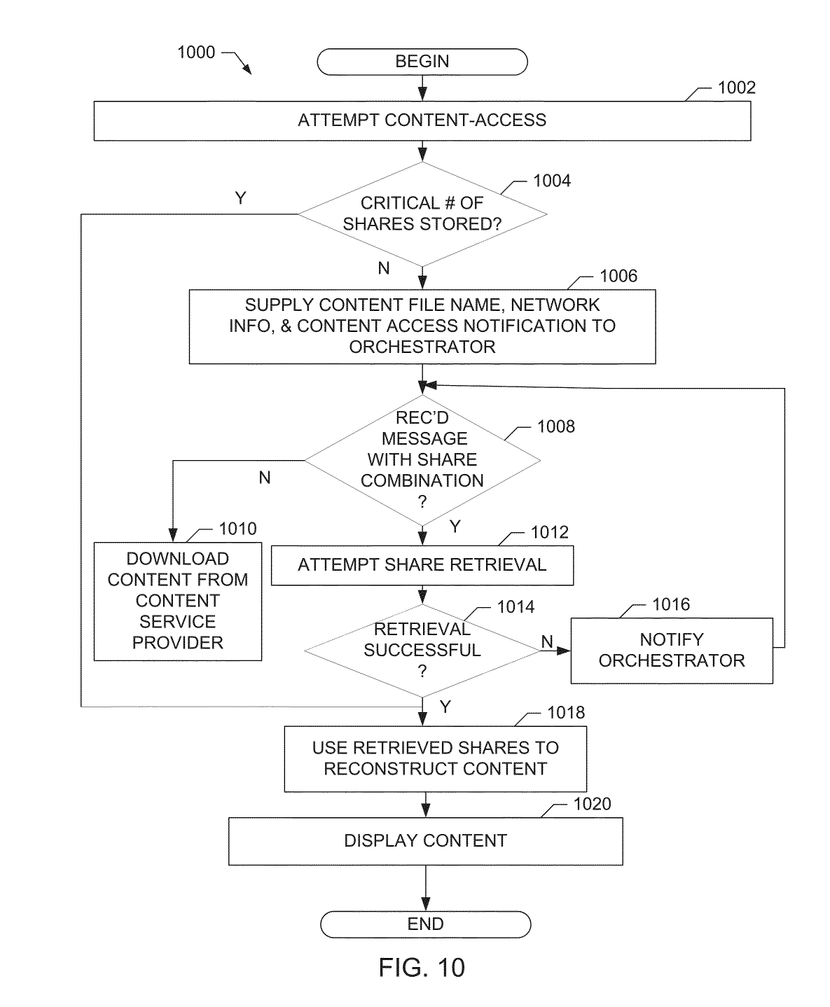

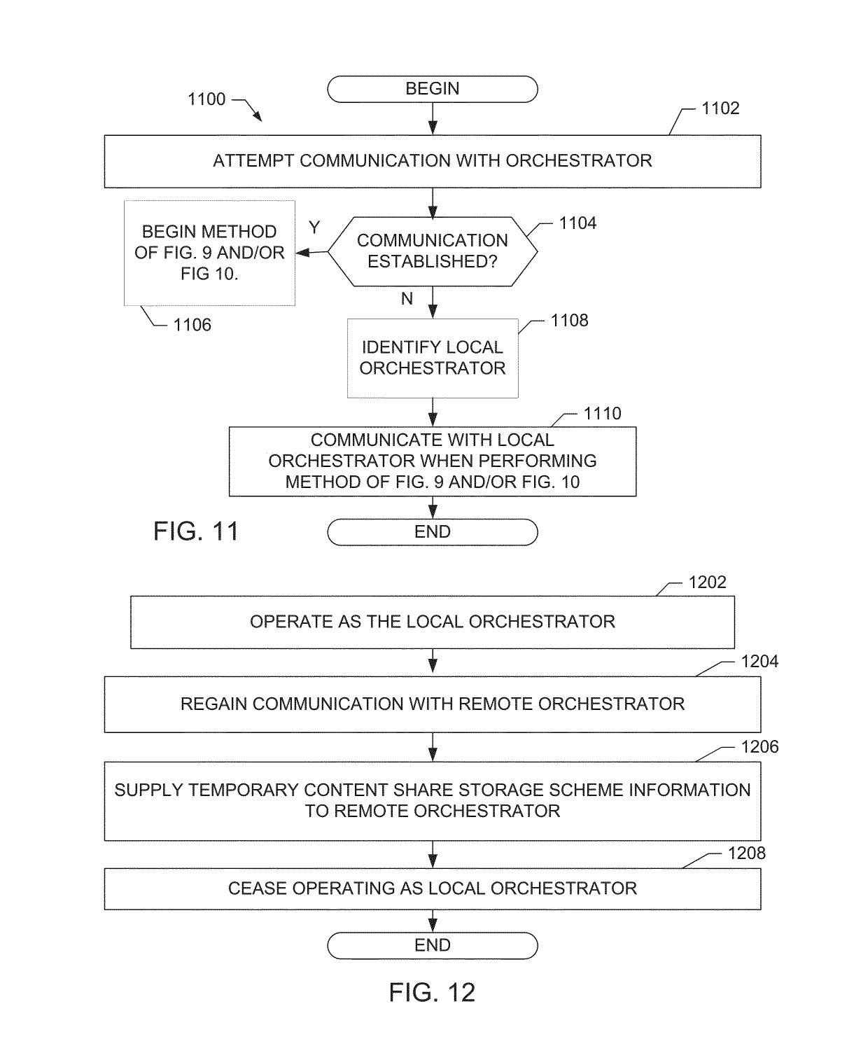

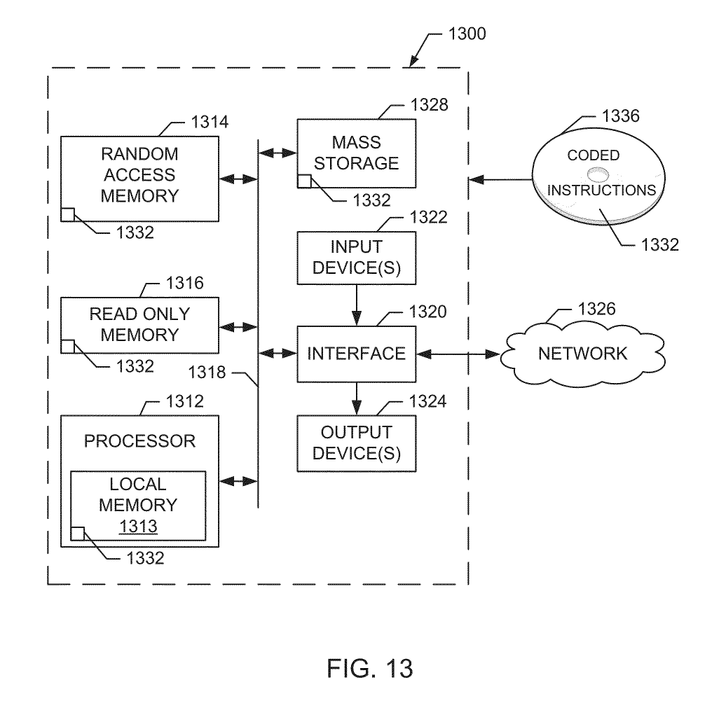

Flowcharts representative of example machine readable instructions for implementing the orchestrator 102 of FIG. 2 are shown in FIGS. 5, 6, 7 and 8 and flowcharts representative of example machine readable instructions for implementing the first client device 128A of FIG. 4 are shown in FIGS. 9, 10, 11 and 12. In these examples, the machine readable instructions comprise one or more programs for execution by a processor such as the processor 1312 shown in the example processor platform 1300 discussed below in connection with FIG. 13. The programs may be embodied in software stored on a tangible computer readable storage medium such as a CD-ROM, a floppy disk, a hard drive, a digital versatile disk (DVD), a Blu-ray disk, or a memory associated with the processor 1312, but the entire program and/or parts thereof could alternatively be executed by a device other than the processor 1312 and/or embodied in firmware or dedicated hardware. Further, although the example programs are described with reference to the flowcharts illustrated in FIGS. 5-12, many other methods of implementing the example orchestrator 102 and/or the first example client device 128A may alternatively be used. For example, the order of execution of the blocks may be changed, and/or some of the blocks described may be changed, eliminated, or combined.

As mentioned above, the example processes of FIGS. 5-12 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 5-12 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

Machine readable instructions 500 that can be used to implement the orchestrator 102 of FIG. 1 and FIG. 2 are shown in FIG. 5. With reference to the preceding figures and associated written descriptions, execution of the machine readable instructions begins at a block 502 at which the orchestrator 102 detects newly downloaded content at a client device (e.g., the first client device 128A) coupled to a first network (e.g., the LAN A). In some examples, the orchestrator 102 detects the newly downloaded content via a content download event notification received at the example event detector 204 of the orchestrator 102. In response to detecting the content download event, at a block 504 the event detector 204 causes the example first data collector 206 of the orchestrator 102 to collect example network/share information such as that described with reference to the TABLE III above. In some examples, the first data collector 206 collects the network/share information by querying the first client device 128A and/or any of the other client devices (e.g., the second client device 128B, the third client device 128C, etc.) coupled to the LAN A 114.

At a block 506, the example share manager 208 of the orchestrator 102 uses the share/network information to generate a corresponding content share storage scheme indicating how the content shares of the downloaded content are to be distributed among the LAN A 114 client devices (e.g., the first client device 128A, the second client device 128B and the third client device 128C). At a block 508, the share manager 208 causes the content share storage scheme to be stored in the data storage device 104 and causes the content share storage scheme to be transmitted to the first client device 128A for use in distributing the content shares among the LAN A 113 client devices (e.g., the first client device 128A, the second client device 128B and the third client device 128C). In some examples, the orchestrator 102 may be notified of the content downloaded event before the content file has been encoded by the first client device 128A. In some such examples, the first data collector 206 can cause a message to be transmitted to the first client device 128A instructing the first client device 128A to encode the content into content shares.

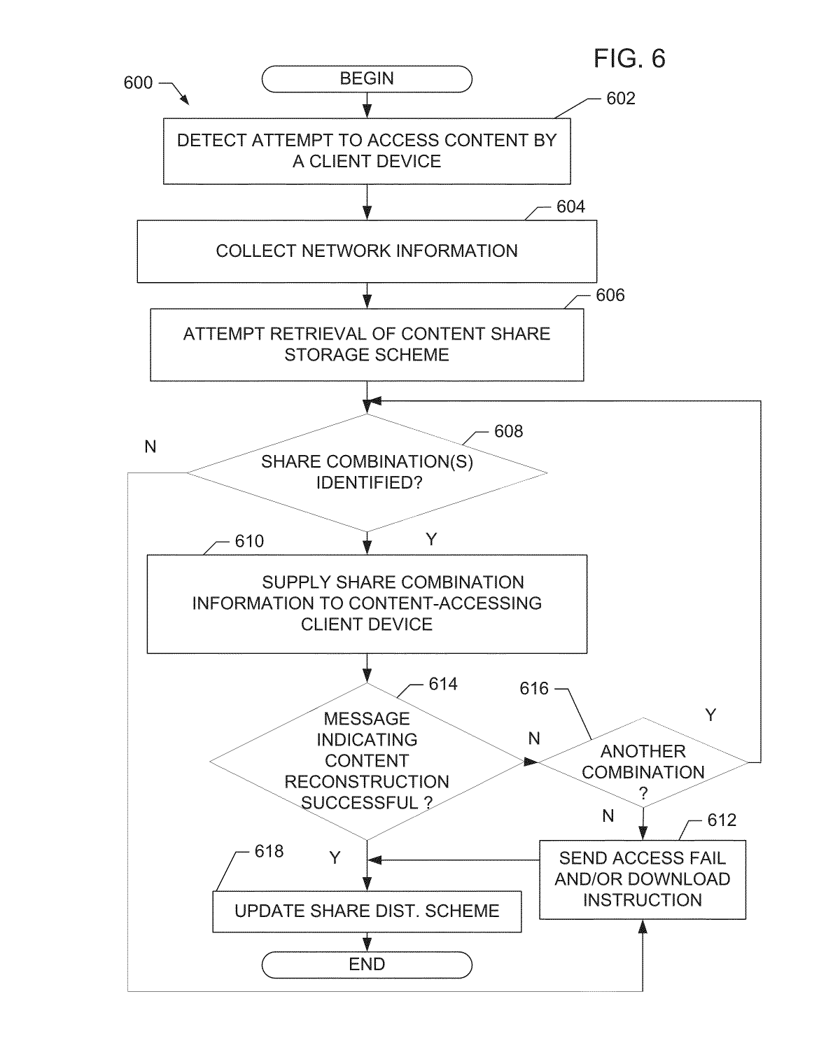

Machine readable instructions 600 that can be used to implement the orchestrator 102 of FIG. 1 and FIG. 2 are shown in FIG. 6. With reference to the preceding figures and associated written descriptions, execution of the machine readable instructions begins at a block 602 at which the example event detector 20 of the orchestrator 102 detects an attempt by a client device (e.g., the second client device 128B) to access a content file (e.g., the IMAGE content file). At a block 604, the event detector 204 notifies the first example data collector 206 that the access event notification has been received causing the first data collector 206 to collect network information as described above with reference to TABLE III. At a block 606, the share manager 208 uses the network information collected by the first data collector 206 to attempt to retrieve a content share storage scheme 210 corresponding to the network (e.g., the LAN A) to which the content-accessing client device (e.g., the second client device 128B) is coupled. At a block 608, the share manager 208 determines whether the retrieved content share storage scheme 210 can be used to identify a combination(s) of different content shares that can be used to recover/reconstruct the content file being accessed. If such a combination(s) of content shares is identified, at a block 610 the example share manager 208 supplies the content-accessing client device (e.g., the second client device 128B) with information identifying combination(s) of shares to be used to reconstruct the accessed content (e.g., the IMAGE content file) and identifying the client devices (e.g., the first client device 128A, the second client device 128B, the third client device 128C, etc.) on which the shares included in the combination(s) are stored.

In some examples, a corresponding combination(s) of content shares cannot be identified by the example share manager 208 because: 1) the content has not previously been downloaded by any of the client devices (e.g., the first client device 128A, the second client device 128B and the third client device 128C) coupled to the LAN A 114 such that the corresponding content share storage scheme 110 is not stored in the data storage 104, 2) the client devices (e.g., the first client device 128A, the third client device 128C, etc.) that store at least some of the content shares included in the combination(s) are not currently coupled to the network (e.g., the LAN A), etc. When such a corresponding combination(s) of content shares cannot be identified by the share manager 208, the content-access fails at a block 612. In some such examples, the share manager 208 causes a content fail message to be delivered to the content accessing client device (e.g., the second client device 128B) and/or instructs the content accessing client device (e.g., the second client device 128B) to perform a content download using the method described with respect to FIG. 5.

At a block 614, the orchestrator 102 determines whether a message has been received from the content-accessing client device (e.g., the second client device 128B) indicating that the content has been successfully retrieved using the identified share combination(s). If such a message is not received from the content-accessing client device (e.g., the second client device 128B), the share manager 208 determines whether all of the possible combinations of shares or any designated number of the combinations have been unsuccessful at a block 616. If so, as described previously, at the block 612, the orchestrator 102 causes a content fail message to be delivered to the content accessing client device (e.g., the second client device 128B) and/or instructs the content accessing client device (e.g., the second client device 128B) to perform a content download using the method described with respect to FIG. 5.

If a message indicating that the content file has been successfully reconstructed is received, at a block 618, the orchestrator 102 updates the content share storage scheme 210 to indicate that the identified combination of shares used to perform the reconstruction is now stored on the content accessing client device (e.g., the second client device 128B). After the update, the orchestrator 102 performs no further operations and the method ends. In some examples, the content-accessing client device (e.g., the second client device 128B) does not retain a copy of the content shares retrieved from other client devices such that the update described for the block 618 is not performed.

In some examples, at the block 610, the share manager 208 supplies the content share storage scheme information to the content-accessing client device (e.g., the second client device 128B) and the content accessing client device uses the information to identify a combination(s) of shares to be used to reconstruct the content.

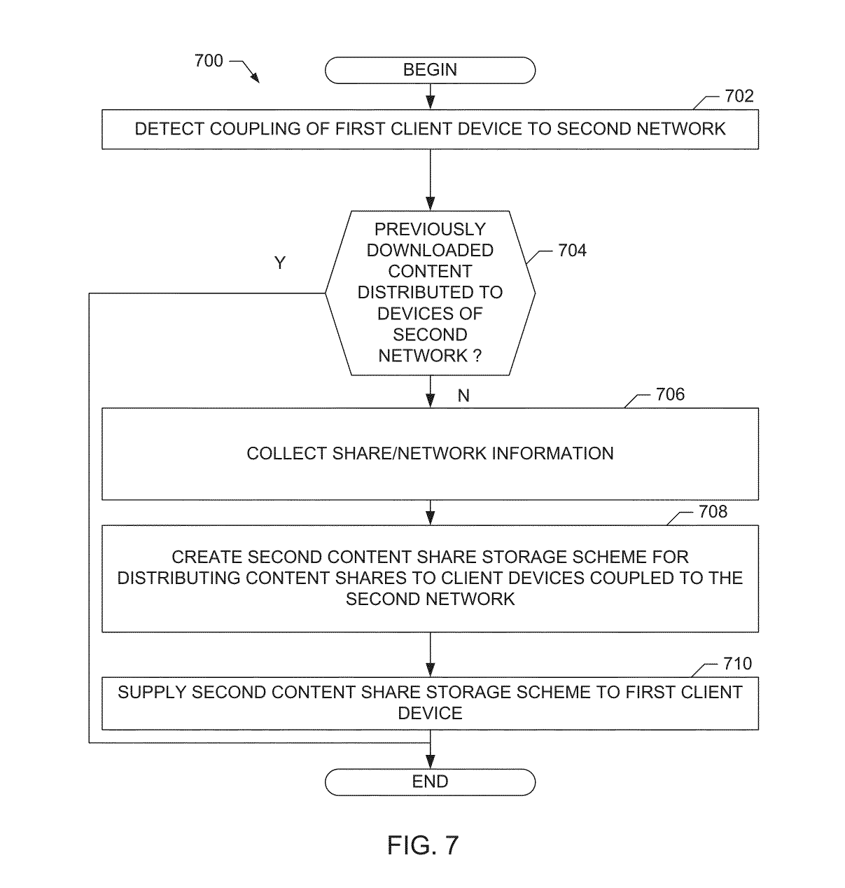

Machine readable instructions 700 that can be used to implement the orchestrator 102 of FIG. 1 and FIG. 2 are shown in FIG. 7. With reference to the preceding figures and associated written descriptions, execution of the machine readable instructions begins at a block 702 at which the example event detector 204 of the orchestrator 102 determines that a client device (e.g., the first client device 128A) that previously downloaded a first content file (e.g., the IMAGE content file) when coupled to a first network (e.g., the LAN A 114) has become coupled to a second network (e.g., the LAN B 118). At a block 704, the example share manager 208 of the orchestrator 102 responds to the detected coupling by determining whether the encoded content shares associated with the first content have been previously distributed to the client devices (e.g., the fourth client device 128D, the fifth client device 128E, etc.) coupled to the LAN B. If so, the orchestrator 102 performs no further operations and the method ends. If not, the first data collector 206 of the orchestrator 102 collects example share/network information as described with reference to TABLE III at a block 706. In some examples, portions of the share information were previously collected in connection with an earlier-created content share storage scheme by which the content shares of the first content file (e.g., the IMAGE content file) were distributed to the LAN A client devices (e.g., the second client device 128B, the third client device 128C, etc.). In some such examples, the share storage information can be collected from the earlier-created content share storage scheme.

At a block 708, the share manager 208 uses the collected information to create a second content share storage scheme to be used to distribute the content shares of the first content (e.g., the IMAGE content file) among the LAN B client devices (e.g., the fourth client device 128D and the fifth client device 128E). At a block 710, the share manager 208 supplies the second content share storage scheme to the first client device 128A for use in distributing the first content shares.

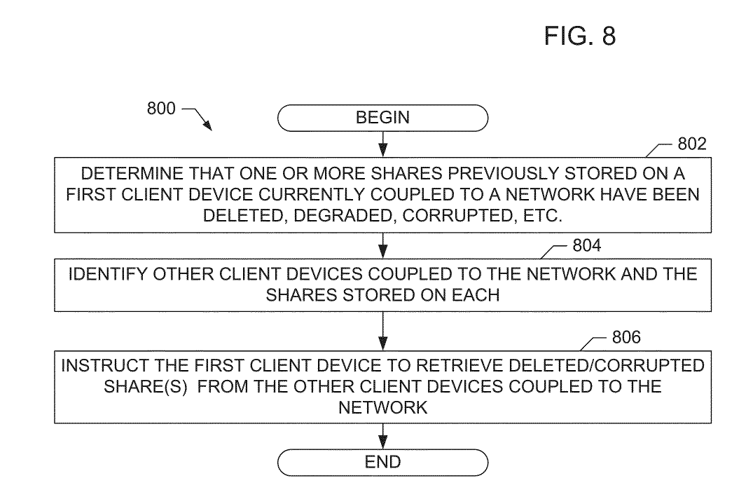

Machine readable instructions 800 that can be used to implement the orchestrator 102 of FIG. 1 are shown in FIG. 8. With reference to the preceding figures and associated written descriptions, execution of the machine readable instructions begins at a block 802 at which the orchestrator 102 determines that one or more shares previously stored on a client device (e.g., the first client device 128A) coupled to a first network (e.g., the LAN A 114) have been deleted, degraded or otherwise corrupted from the first client device 128A. In some examples, the orchestrator 102 makes this determination by causing the first data collector 206 to poll the first client device 128A for information regarding the content shares stored thereon. In some examples, the orchestrator 102 makes this determination when a client device (e.g., the second client device 128B) attempting to access content notifies the share manager 208 of the orchestrator 102 that one or more of a combination of the content shares cannot be retrieved from the first client device 128A because one or more of the combination of shares is no longer present on the first client device 128A. The orchestrator 102 can also make this determination when the second client device 128B notifies the share manager 208 that a combination of retrieved shares cannot be successfully used to reconstruct a content file because one or more of the combination of content shares retrieved from the first client device is corrupt.

At a block 804, the share manager 208 uses the content share storage scheme created for the LAN A 114 to identify example share/network information, such as the identities of the client devices (e.g., the second client device, the third client device, etc.) coupled to the LAN A 114 and the content shares stored on each such client device. At a block 806, the example share manager 208 uses the identified share/network information to generate a message instructing the first client device 128A having the missing (e.g., deleted and/or corrupted) share(s) to delete such corrupt content share(s) (if applicable) and to collect/retrieve an uncorrupted copy of the content share(s) from another of the client devices coupled to the LAN A 114.

In some examples, when none of the other client devices (e.g., the first client device 128A, the second client device 128B, the third client device 128C, etc.) coupled to the network have a copy of the corrupt/deleted content share, the share manager 208 at the block 804 can instruct the client device associated with the corrupt/deleted content share to retrieve a threshold number of the total content shares of the corresponding content and to use the threshold number of content shares to reconstruct/retrieve the corresponding content. The share manager 208 can further instruct the client device to decode the reconstructed/retrieved to generate the total number of the content shares corresponding to the content and to retain all of the content shares or to retain only a copy of the corrupt/deleted content share. In some such examples, the share manager 208 determines the appropriate content shares to be retained, distributed, etc., by accessing the previously generated, corresponding content share distribution scheme. In some such examples, the share manager 208 updates the corresponding content share distribution scheme to reflect any changes to the content shares stored on any of the client devices resulting from the described content share retrieval operations.

Machine readable instructions 900 that can be used to implement the example first client device 128A of FIG. 1 are shown in FIG. 10. Although the instructions are described as being operations performed by the first client device 128A, the operations can also be also performed by any of the second example client device 128B, the third example client device 128C, the fourth example client device 128D and/or the fifth example client device 128E). With reference to the preceding figures and associated written descriptions, execution of the machine readable instructions begins at a block 902 at which the first client device 128A detects the download of a content file at the content receiver 403 of the first client device 128A. At a block 904, the example second content encoder 404 of the first client device 128A retrieves a content encoding key. In some examples, the encoding key is stored in the share storage 406 or any other storage device associated with the first client device 128. In some examples, the encoding key is stored on one or more other of the client devices (e.g., the second client device 128B, the third client device 128C, etc.).

At a block 906, the first client device 128A uses the encoding key to encode the content file into a total number of different content shares and causes the different content shares to be deposited in the share storage 406. The first client device 128A notifies the example orchestrator 102 that the content has been downloaded via a download event notification inserted by the message generator 408 into a message to be transmitted to the orchestrator 102 via the message/data transceiver 410 at a block 908.

In addition to notifying the orchestrator 102 that the content has been downloaded, at a block 910 the example second data collector 412 collects network information (e.g., the identity of the network to which the mobile network device is currently coupled, the identities of the other network devices coupled to the identified network and the storage capacity associated with the other network devices) and collects available storage capacity information from each client device coupled to the network. In some examples, the first client device 128A is coupled to the LAN A 114 when the content is downloaded such that the second example data collector 412 collects the information by communicating with the other network devices (e.g., the second client device 128B, the third client device 128C, etc.) coupled to the LAN A 114. The message generator 408 transmits the collected network information to the orchestrator 102 via the example message/data transceiver 410. At the block 910, the second data collector 412 also collects share-related information (e.g., the total number of different content shares, the threshold number of different content shares needed to reconstruct the content file, the sizes of the different content shares, share identifying information, etc.) and causes the share-related information to be transmitted to the orchestrator 102.

In response to the message containing the network/share information, the orchestrator 102 supplies a message to the first client device 128A containing corresponding content share storage scheme information indicating a manner in which the content shares of the downloaded content are to be distributed among the first client device 128A, the second client device 128B and the third client device 128C. At a block 912, the message/data transceiver 410 of the first client device 128A receives the content share storage scheme information and at a block 914, the example share distributor/receiver 414 of the first client device 128A distributes the content shares to the second client device 128B and the third client device 128C and retains content shares in accordance with the received content share storage scheme information. In some examples, the received content share storage scheme information can be stored in the scheme storage 416 on the first client device 128A for later use in identifying the client devices (e.g., first client device 128A, second client device 128B, the third client device 128C) on which the distributed content shares have been stored.

Machine readable instructions 1000 that can be used to implement the example first client device 128A of FIG. 1 are shown in FIG. 10. Although the instructions are described as being operations performed by the first client device 128A, the operations can also be also performed by any of the second example client device 128B, the third example client device 128C, the fourth example client device 128D, the fifth example client device 128E, etc.). With reference to the preceding figures and associated written descriptions, execution of the machine readable instructions begins at a block 1002 at which the first client device 128A attempts to access content via the example content access tool 418. At a block 1004, the content access tool 418 notifies the example second data collector 412 of the attempted content access causing the second data collector 412 to determine whether a threshold number of content shares associated with the content being accessed are stored in the example share storage 406. In some examples, the second data collector 412 uses information supplied by the content access tool 418, including the name of the content file being accessed, to identify any corresponding content shares stored in the share storage 406. A threshold number of the content shares associated with the content being accessed may be stored in the share storage when, for example, the content to be accessed has been previously accessed and/or downloaded by the first client device 128A.

If the threshold number of content shares are stored in the example share storage 406 of the first client device 128, the example content reconstructor 420 uses the stored content shares to reconstruct and display the content as described with reference to a block 1018 and a block 1020 as described in greater detail below.

If at least some of the content shares of the content being accessed are stored in the example share storage 406 but the number is insufficient to reconstruct the content or if none of the content shares are stored in the example share storage 406, at a block 1006, the example second data collector 412 collects network information for the network (e.g., the LAN A 114) to which the first device 128A is coupled at the time of the content access and inserts a content access notification into a message supplied to the message/data transceiver 410 for delivery to the orchestrator 102 (see FIG. 1). In addition to the collected network information, the content access notification includes the name of the content file being accessed and a request for a share combination that can be used to reconstruct the content.

In some examples, the example message/data transceiver 410 of the example first client device 128A determines at a block 1008 whether a responsive message containing a combination of shares has been received from the example orchestrator 102. If, for example, the content being accessed has not previously been downloaded by any the example client devices associated with or currently coupled to the example LAN A 114 (or all possible combinations of content shares are insufficient to reconstruct the content as described below), a message containing a combination of shares is not received and the first client device 128A proceeds at a block 1010 to perform the content download operations described with reference to FIG. 9. In some examples, the content download operations are performed by the first client device 128A in response to a message instructing the first client device to perform the download operations. In some examples, the first client device 128A automatically performs the content download operations of FIG. 9 a threshold amount of time after the request for a share combination has been transmitted without a corresponding response from the orchestrator 102. In some examples, the first client device 128A is not coupled to a content service provider when the content is accessed such that the content cannot be downloaded after a failed access attempt. In some such examples, the first client device 128 can display a content-access failure message to the user.

If the first client device 128A receives a message from the orchestrator 102 identifying a combination(s) of the threshold number of different content shares associated with the accessed content and further identifying the other client devices on which the different content shares of the combination are stored, at a block 1012, the example share distributor/retriever 414 attempts to retrieve the content shares identified by the orchestrator 102 from the identified client devices.

At a block 1014, the example share distributor/retriever 414 determines whether the attempted share retrieval was successful. Share retrieval can be unsuccessful for any of a variety of reasons including: 1) one or more of the network devices that are identified as storing a different share associated with the combination no longer has the different share in storage, 2) the stored share(s) are corrupted, the network device storing the content share has decoupled from the network before the share could be retrieved, 3) the content was not previously downloaded by any of the client devices coupled to LANA 114, etc.

If the content shares are not successfully retrieved, the share distributor/retriever 414 notifies the message generator 408 which creates a message containing a request for a second combination of different content shares at a block 1016. The message containing the request for a second share combination is also transmitted to the orchestrator 102 via the message/data transceiver 414 at the block 1016. The first client device 128A then proceeds to perform the operations described at the block 1008 and the blocks subsequent thereto as described above.

If the combination of content shares is successfully retrieved, an example content reconstructor 420 uses the retrieved content shares to reconstruct the content at the block 1018 and supplies the reconstructed content to one or more example content display tools 422 for display at a block 1020. After the content has been displayed the method ends.

Machine readable instructions 1100 that can be used to implement the example first client device 128A of FIG. 1 and FIG. 4 are shown in FIG. 11. Although the instructions are described as being operations performed by the example first client device 128A, the operations can also be performed by any of the second example client device 128B, the third example client device 128C, the fourth example client device 128D, the fifth example client device 128E, etc.). With reference to the preceding figures and associated written descriptions, execution of the machine readable instructions begins at a block 1102 at which the first client device 128A, when coupled to the LAN A 114 attempts to communicate with the orchestrator 102. In some examples, the first client device 128A sends a notification to the example orchestrator 102 indicating that the first content device 128A has attempted to access content or has downloaded content as is described with respect to FIG. 9 and FIG. 10, respectively (see block 908 of FIG. 9 for content download notification and block 1006 of FIG. 10 for content access notification). At a block 1104, the data/message transceiver 410 determines whether communication has been established with the orchestrator 102. If communication has been established, at a block 1106, the first client device 102 begins the method described with respect to the flowchart of FIG. 9 and/or the method described with respect to the flowchart of FIG. 10, as applicable. If communication is not successfully established, at a block 1108, the first client device 128A identifies which, if any, of the client devices (e.g., the second client device 128B, the third client device 128C, etc.) coupled to the LAN A 114 have been designated to operate as a local orchestrator. The first client device 128A can make this identification by polling the second client device 128B, the third client device 128C, etc. Provided that a local orchestrator (e.g., the second client device 128B) has been designated, at a block 1110, the first client device 128A communicates with the designated local orchestrator (e.g., the second client device 128B) instead of the orchestrator 102 when performing the operations described with respect to the FIG. 9 (if a content download has occurred) and/or when performing the operations described with respect to FIG. 10 (if a content access has been attempted). In the event that a local orchestrator has not been designated, the first client device 128A can be configured to: 1) attempt to download the content being accessed from a client service provider instead of trying to retrieve the content using previously stored shares and/or 2) notify the orchestrator 102 of a content download at a later time when communication with the orchestrator 102 can be established. After the content access or content download method has been completed, the method ends.

Machine readable instructions 1200 that can be used to implement the example first client device 128A of FIG. 1 and FIG. 2 are shown in FIG. 12. Although the instructions are described as being operations performed by the example first client device 128A, the operations can also be also performed by any of the second example client device 128B, the third example client device 128C, the fourth example client device 128D, the fifth example client device 128E, etc.). With reference to the preceding figures and associated written descriptions, execution of the machine readable instructions begins at a block 1202 at which the first client device 128A operates as a local orchestrator when communication with the example orchestrator 102 cannot be established. The operations performed by the first client device 128A include the operations described with respect to the methods of FIG. 9 and FIG. 10, as applicable. The first client device 128A creates and stores temporary content share storage scheme information while operating as the local orchestrator for the LAN A 114. At a block 1204, the first client device 128A regains communication with the orchestrator 102. To regain communication, the first client device 128A may poll the orchestrator 102 until receiving a response, the orchestrator 102 may notify the first client device that communication is reestablished, etc. At a block 1206, communication is established and the first client device 128A supplies the temporary content share storage scheme information to the orchestrator 102 which synchronizes the information with content share storage scheme information stored on the orchestrator 102. At a block 1208, the first client device 128A ceases operating as the local orchestrator 102 and the method ends.

FIG. 12 is a block diagram of an example processor platform 1300 capable of executing the instructions of FIGS. 5-12 to implement the orchestrator 102 of FIG. 1 and FIG. 2 and the first client device of FIG. 4. The processor platform 1300 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors or controllers from any desired family or manufacturer.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), and/or a PCI express interface.

In the illustrated example, one or more input devices 1322 are connected to the interface circuit 1320. The input device(s) 1322 permit(s) a user to enter data and commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1320 of the illustrated example, thus, typically includes a graphics driver card, a graphics driver chip or a graphics driver processor.

The interface circuit 1320 of the illustrated example also includes a communication device such as a transmitter, a receiver, a transceiver, a modem and/or network interface card to facilitate exchange of data with external machines (e.g., computing devices of any kind) via a network 1326 (e.g., an Ethernet connection, a digital subscriber line (DSL), a telephone line, coaxial cable, a cellular telephone system, etc.).

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, RAID systems, and digital versatile disk (DVD) drives.

The coded instructions 1332 of FIGS. 1-12 may be stored in the mass storage device 1328, in the volatile memory 1314, in the non-volatile memory 1316, and/or on a removable tangible computer readable storage medium such as a CD or DVD.

From the foregoing, it will appreciated that above disclosed methods, apparatus and articles of manufacture reduce costs associated with storing and accessing a content file and reduces the risks that the content is deleted or lost by distributing the content shares among multiple client devices of a network.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to store a content file, the method comprising:
generating, with a processor remote from a first client device storing content shares of the content file, a first content share storage scheme identifying a second client device to which a first subset of a first combination of the content shares is to be distributed for storage when a first client device is coupled to a first local area network; and,
generating, with the processor, a second content share storage scheme identifying a third client device to which a first subset of a second combination of the content shares is to be distributed for storage when the first client device is coupled to a second local area network, the first and second combinations each having a threshold number of the content shares determined to be sufficient to reconstruct the content file, the threshold number being less than a total number of the content shares into which the content file was encoded and each of the threshold number of content shares being different content shares.

2. The method of claim 1 wherein the first combination and the second combination are a same combination.

3. The method of claim 1 wherein the first content share storage scheme indicates that a second subset of the first combination is to be retained on the first client device.

4. The method of claim 3 further comprising:
in response to an attempt by the second client device to access the content file, using the first content share storage scheme to determine that the second subset is stored on the first client device; and
instructing the second client device to retrieve the second subset of the first combination from the first client device.

5. The method of claim 3 further comprising:
in response to an attempt by the second client device to access the content file, determining whether the first client device is coupled to the first local area network;
if the first client device is coupled to the first local area network, instructing the second client device to retrieve the second subset of the first combination from the first client device; and
if the first client device not coupled to the first local area network, using the first content share storage scheme to determine whether the second subset of the first combination is stored on any other client device determined to be coupled to the first local area network.

6. The method of claim 4 further comprising:
receiving an indication that the second subset of the first combination has not been successfully retrieved from the first client device; and
accessing the first content share storage scheme to determine whether the first subset of the first combination is stored on any other client devices coupled to the first local area network.

7. (canceled)

8. The method of claim 1 wherein the first storage scheme indicates that the first client device is to retain all of the content shares, the method further comprising:
determining that a first of the content shares stored on the second client device has been corrupted; and
instructing the second client device to retrieve a copy of the first content share from the first client device.

9. An apparatus to store a content file, the apparatus comprising:
a memory having machine readable instructions stored thereon; and
a processor remote from a first client device storing content shares of the content file, the processor to execute the instructions to perform operations comprising:
generating a first content share storage scheme identifying a second client device to which a first subset of a first combination of the content shares is to be distributed for storage when the first client device is coupled to a first local area network; and,
generating a second content share storage scheme identifying a third client device to which a first subset of a second combination of the content shares is to be distributed for storage when the first client device is coupled to a second local area network, the first and second combinations each having a threshold number of the content shares determined to be sufficient to reconstruct the content file, the threshold number being less than all of the content shares into which the content file was encoded.

10. The apparatus of claim 9 wherein the first combination and the second combination are a same combination.

11. The apparatus of claim 9 wherein the first content share storage scheme indicates that a second subset of the first combination is to be retained on the first client device.

12. The apparatus of claim 11 wherein the operations further comprise:
using the first content share storage scheme to determine that the second subset is stored on the first client device in response to an attempt by the second client device to access the content file; and
instructing the second client device to retrieve the second subset of the first combination from the first client device.

13. The apparatus of claim 11 wherein the operations further comprise:
determining whether the first client device is coupled to the first local area network in response to an attempt by the second client device to access the content file;
if the first client device is coupled to the first local area network, instructing the second client device to retrieve the second subset of the first combination from the first client device; and
if the first client device not coupled to the first local area network, using the first content share storage scheme to determine whether the second subset of the first combination is stored on any other client device determined to be coupled to the first local area network.

14. The apparatus of claim 12 wherein the operations further comprise:
receiving an indication that the second subset of the first combination has not been successfully retrieved from the first client device; and
accessing the first content share storage scheme to determine whether the first subset of the first combination is stored on any other client devices coupled to the first local area network.

15. (canceled)

16. (canceled)

17. A tangible machine readable storage medium comprising machine readable instructions which, when executed, cause a machine to perform operations comprising:
generating a first content share storage scheme identifying a first client device to which a first subset of a first combination of the content shares is to be distributed for storage when a second client device storing the content shares is coupled to a first local area network; and,
generating a second content share storage scheme identifying a third client device to which a first subset of a second combination of content shares is to be distributed for storage when the second client device is coupled to a second local area network, the first and second combinations each having a threshold number of the content shares determined to be sufficient to reconstruct the content file, the threshold number being less than a total number of the content shares into which the content file was encoded and each of the threshold number of content shares being different content shares.

18. The tangible machine readable medium of claim 17 wherein the first combination and the second combination are a same combination.

19. The tangible machine readable medium of claim 17 wherein the first content share storage scheme indicates that a second subset of the first combination is to be retained on the second client device.

20. The tangible machine readable medium of claim 19 wherein the operations further comprise:
using the first content share storage scheme to determine that the second subset is stored on the second client device in response to an attempt by the first client device to access the content file; and
instructing the first client device to retrieve the second subset of the first combination from the second client device.

21. The tangible machine readable medium of claim 19 wherein the operations further comprise:
determining whether the second client device is coupled to the first local area network in response to an attempt by the first client device to access the content file; and
if the second client device is coupled to the first local area network, instructing the first client device to retrieve the second subset of the first combination from the first client device; or
if the second client device not coupled to the first local area network, using the first content share storage scheme to determine whether the second subset of the first combination is stored on any other client device determined to be coupled to the first local area network.

22. The tangible machine readable medium of claim 20 wherein the operations further comprise:
receiving an indication that the second subset of the first combination has not been successfully retrieved from the second client device; and
accessing the first content share storage scheme to determine whether the first subset of the first combination is stored on any other client devices coupled to the first local area network.

23. The tangible machine readable medium of claim 17 wherein the operations further comprise:
determining that one of the client devices coupled to the first local area network has been operating as a local orchestrator; and
synchronizing first content share storage scheme information received from the local orchestrator with second content share storage scheme information.

24. (canceled)
